(19) United States
(12) Patent Application Publication
(10) Pub. No.: US 2010/0230220 A1
(43) Pub. Date: Sep. 16, 2010

(54) DISK BRAKE AND LINING CARRIER AND PRESSURE PLATE FOR A DISK BRAKE OF SAID TYPE

(75) Inventors: Marcus Keller, Weinheim (DE); Markus Ritter, Ilvesheim (DE)

Correspondence Address: Schwabe Williamson & Wyatt;PACWEST CENTER, SUITE 1900, 1211 SW FIFTH AVENUE, PORTLAND, OR, 97204, US

(73) Assignee: WABCO RADBREMSEN GMBH, Mannheim (DE)

(21) Appl. No.: 12/302,015

(22) PCT Filed: May 22, 2006
(86) PCT No.: PCT/EP07/04389

§ 371 Date: May 12, 2010

(30) Foreign Application Priority Data
May 22, 2006 (DE) 102006023964.4

(51) Int. Cl. F16D 65/097; F16D 65/092; F16D 65/095; F16D 55/225

(52) U.S. Cl. 188/73.31; 188/234

(57) ABSTRACT

The invention relates to a disk brake, in particular for utility vehicles, having a brake disk (30) with a rotational axis (D), having a pressing device (10, 38) which, for braking, is pressed in the direction of the rotational axis against the brake disk, and a holding-down device (40), wherein the pressing device has a projection (16) which, in an installed state, extends through a passage opening (46) in the holding-down device. It is provided according to the invention that the projection, in the installed state, projects in the axial direction of the brake disk beyond a delimitation of the passage opening.

The invention relates to a disk brake, in particular for utility vehicles, having

a brake disk with a rotational axis,

a pressure device which, for braking, is pressed in the direction of the rotational axis against the brake disk, and

a holding-down device, wherein

the pressing device exhibits a projection which, in the installed state, extends through a passage opening in the holding-down device.

Disk brakes of the type mentioned in the introduction are known, for example from EP 0 694 707 A2. In these disk brakes, the holding-down device is designed in the form of a leaf spring designated as a holding-down spring.

The holding-down spring is constructed with radial moldings such that it is supported, in the installed state, in both rotational directions of the brake disk by a holding-down clip attached to the brake caliper. It is also kept stationary in the circumferential direction. But as it engages, by means of the longitudinally shaped passage openings in its lateral spring legs, behind the projections of a pressing device constructed in the form of a lining carrier or a pressure plate, it follows the axial movement of the pressing device in the direction to/from the brake disk. In this way, the leaf spring and the pressing device move together in the axial direction of the brake disk.

But as the passage openings in the spring legs have a greater length than the projections of the pressing device in the circumferential direction, it is possible for a lateral (tangential) relative movement to occur between the holding-down spring and the pressing device, depending on the rotational direction of the brake disk and the rotational pull of the brake pads. In other words, the pressing device can execute lateral (tangential) movements against the elastic reset force of the PTC-EP2007-004389 stationary holding-down spring because the passage openings in the spring legs with their longitudinal design allow for this to happen. This free lateral (tangential) movability against each other has the advantage that no full spring preloading is present in the beginning at the time of installation. The spring preloading does not increase until the holding-down clip contacts the holding-down spring via the radial projections and presses down on both the pressing device and the holding-down spring while being attached to the brake caliper, so that they assume their installation positions. It is not until this point that the full spring preloading takes effect (here, radially inwards and, if desired, also tangentially in a preferred rotational direction of the disk in accordance with an installation offset of the holding-down clip in the disk brake, in relation to the central axis).

In principle, the above-described configuration proved to be of value. But during vehicle operation and especially in extreme uses in the field, there may be situations leading to impairments of the disk brake.

Such impairments may be e.g. radial vibrations on bad road stretches or accretion of dirt and corrosion.

In particular, large and rapidly repeating axial movements with the disk brake attached thereto lead to large radial movements of the brake pads so that the holding-down springs and especially their spring legs can “rebound” due to the vibrations causing them to lift off their contact and holding areas on the pressing device. In such a case, the initial position (resting position) which is important for the functioning of the spring is no longer ensured. In that case, it is possible that the projection no longer extends into the passage opening.

A disk brake similar to the above-described disk brake is known from WO 92/00465. In this disk brake, the projection projects beyond a delimitation of the passage opening in the circumferential direction of the disk brake in an intermediate state, i.e. when the holding-down device has touched down on the pressing device but is not yet tensioned.

The invention is based on the problem of further developing the disk brake of the type mentioned in the introduction so that the projection also reliably extends through the passage opening under extreme conditions. In doing so, a potential movability of the pressing device relative to the holding-down device shall be maintained in the tangential direction of the brake disk. It is preferred that the two devices are capable of being moved jointly in the axial direction of the brake disk.

In accordance with the invention, this problem is solved in that the projection, in the installed state, projects beyond a delimitation of the passage opening in the axial direction of the brake.

In other words, the projection engages behind the holding-down device in the installed state so that the holding-down device cannot move beyond a preset degree in the radial direction of the brake in relation to the pressing device. Instead, it strikes against the portion of the projections projecting beyond the axial delimitation. In this way, a rebound delimitation is implemented.

In accordance with the invention, the holding-down device is preferably a spring, specifically a leaf spring.

According to the invention, the projection can project beyond a delimitation of the passage opening in the axial direction of the brake, either facing the brake disk or facing away from the brake disk. But according to the invention, it is preferred that it projects beyond a delimitation of the passage opening in the axial direction of the brake disk, both facing the brake disk and facing away from the brake disk.

In this way, a particularly reliable protection against “rebounding” is provided.

In the top view of its free end, the projection may be twisted vis-à-vis the passage opening.

In other words, based on this embodiment, the protrusion of the projections is achieved by twisting, whereas the projection would not protrude in the untwisted state.

In accordance with an especially preferred embodiment of the invention, it is provided that the free end of the projections is pitched with respect to the section of the projections extending through the passage opening in the installed state.

This embodiment can be produced in a particularly simple manner.

Here, the setting angle is preferably 5° to 40°, and specially preferred 5° to 20°.

According to the invention, the projection is preferably compressed, flanged, bent and/or twisted, at least in sections, in order to form the projecting end.

These implementations are especially suitable when the pressing device is made of a malleable material, such as e.g. steel.

The projecting end can also be cast on.

This embodiment is more likely to be indicated with pressing devices made from a cast material.

In accordance with a specially preferred embodiment of the invention, a surface of the projection facing the holding-down device in the installed state corresponds to the respective surface of the holding-down device.

This embodiment guards against tilting or jamming in the event of relative movements.

The pressing device frequently exhibits two or more projections which extend through one passage opening, respectively one passage opening each, in the installed state. According to the invention, it is preferred in the event of two projections that one of the projections projects beyond a delimitation of a passage opening on one side in the axial direction of the brake disk, and that the other projection projects on the other side in the axial direction of the brake disk. This facilitates the assembly to a considerable extent because the pressing device—especially if it is implemented as a leaf spring—can be installed by twisting in a very simple way. Similarly, the disassembly is also simplified. In addition, the two projections mutually act as anti-tilt devices.

This embodiment simplifies the attachment of the holding-down device to the pressing device.

As indicated above, the pressing device is preferably e.g. a lining carrier.

But it can also be a pressure plate.

Preferably, the pressing device and the holding-down device are movable against each other in the installed state in the tangential direction of the brake disk. This can be ensured, for example, by making the passage opening longer in its longitudinal extension than the projection in its respective extension. Here, the movability can refer only to a central and/or one of the two end sections of the holding-down device. But it can also refer to the entire holding-down device. But, according to the invention, it is not ruled out that one or both of the end sections of the holding-down device are fixed to the pressing device, at least in the circumferential or tangential direction of the brake disk, as it is the case, for example, in the brakes in accordance with EP 248 385 B1, DE 100 26 547 C2 and DE 103 28 194 B3.

In addition to the disk brake described above in detail, the invention relates not only to the disk brake as a whole or to components of the disk brake, but also individually to a lining carrier and a pressure plate for such a disk brake.

In the following, the invention will be explained in more detail with reference to the attached drawing, using preferred embodiments.

In the drawing

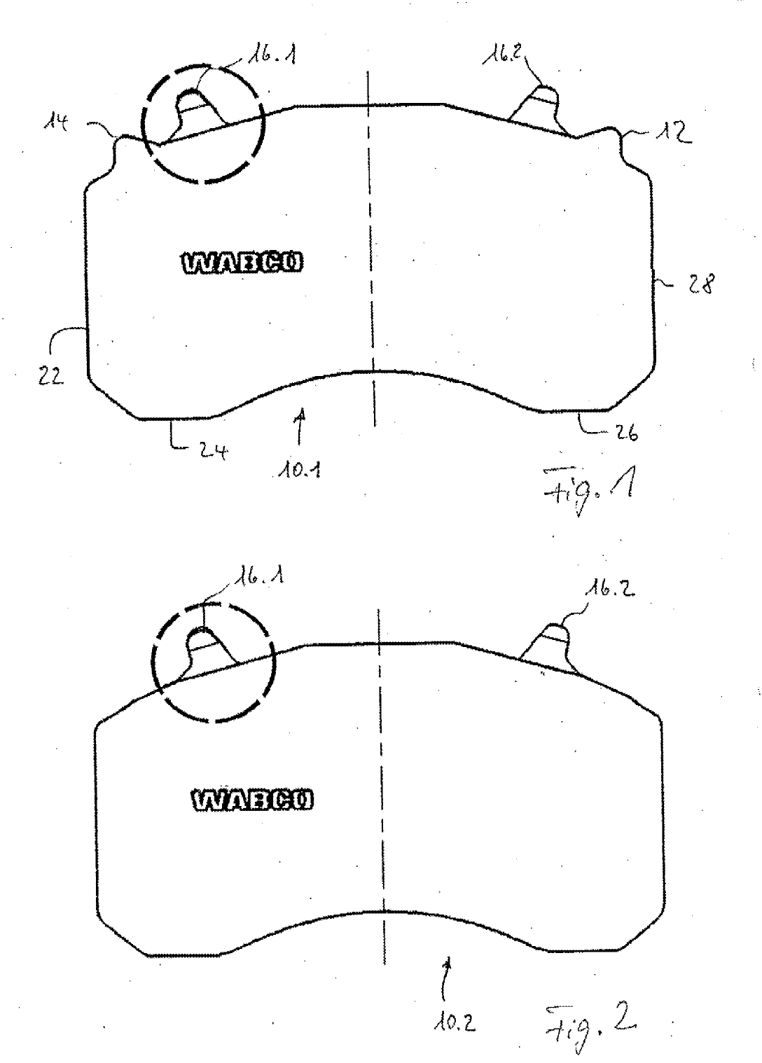

FIG. 1 is a view of a lining carrier in accordance with an embodiment of the invention.

FIG. 2 is the same view as FIG. 1, but of a different embodiment of the invention.

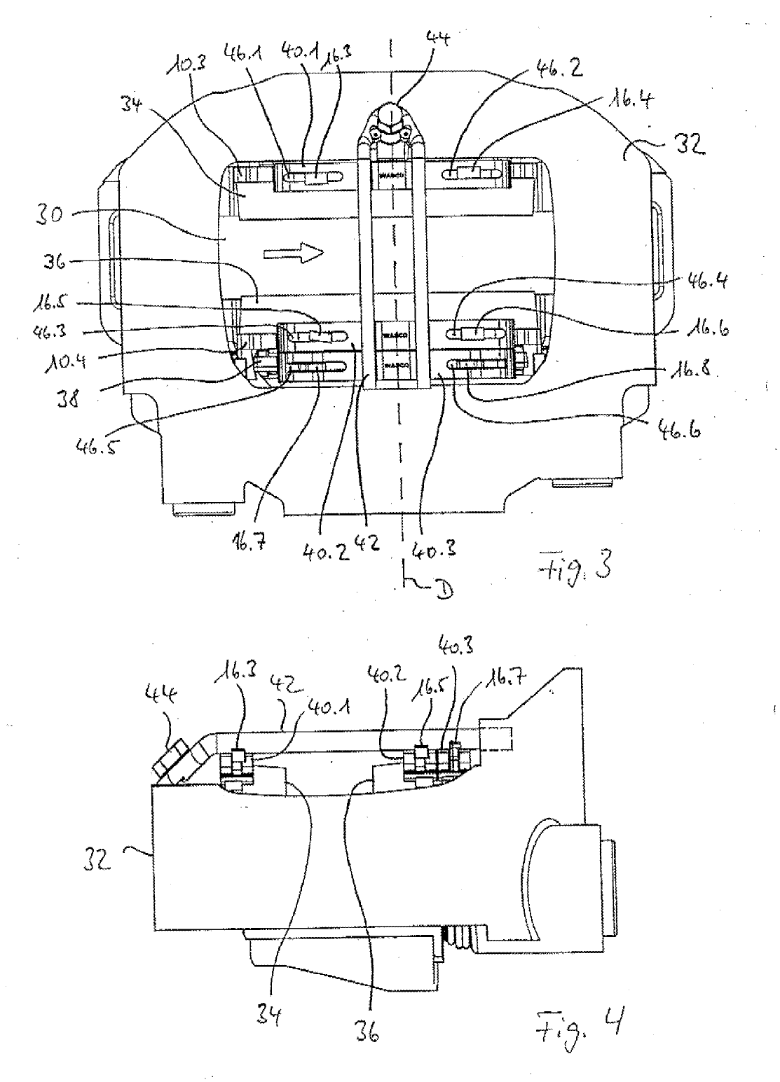

FIG. 3 is a schematic top view of a disk brake in accordance with an embodiment of the invention.

FIG. 4 is a side view of the disk brake in accordance with FIG. 3.

FIG. 5 is a schematic top view of a part of a disk brake in accordance with a further embodiment of the invention.

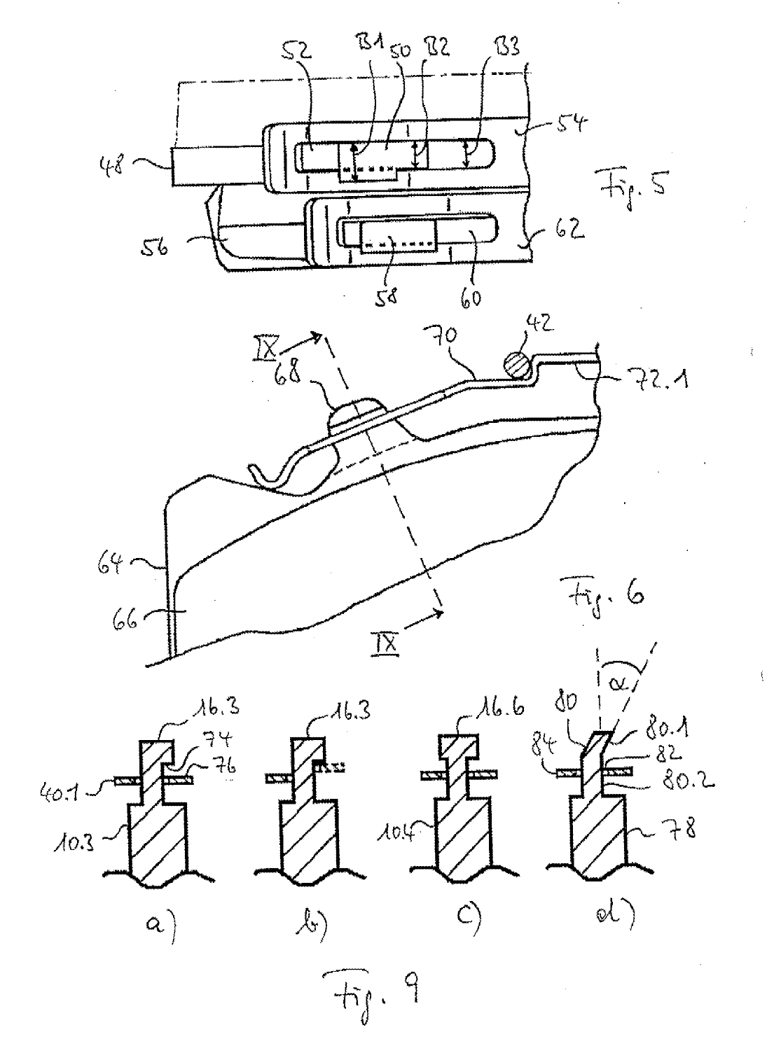

FIGS. 6 to 8 are schematic sectional partial views of different embodiments of the invention and

FIG. 9 are sectional views along the IX-IX line in FIG. 6 of different embodiments of the invention.

FIGS. 1 and 2 each show a lining carrier 10.1, 10.2. They differ in that the lining carrier 10.1 based on FIG. 1 exhibits projections 12, 14 to support free ends of a holding-down spring which will be explained in more detail below.

Such projections are not provided in the lining carrier 10.2 based on FIG. 2. Here, the free ends of the holding-down spring are directly supported by the lining carrier 10.2.

But both lining carriers 10.1 and 10.2 exhibit projections 16.1, 16.2 which implement the invention. The lining carrier 10.1 and 10.2 are movably kept and guided in a brake carrier or a brake caliper at the contact surfaces 22, 24, 26, 28. It should be noted that both the design of the contact surfaces 22, 24, 26, 28 and their guide/support in the brake and/or in the brake carrier can also be different depending on the type of the brake.

The disk brake shown in the top view of FIG. 3 comprises a brake disk 30, a brake caliper 32, a lining carrier 10.3 with a friction lining 34, a lining carrier 10.4 with a friction lining 36 and a pressure plate 38. The lining carrier 10.3 and 10.4 as well as the pressure plate 38 are pushed in the radial direction of the brake by a holding-down spring 40.1, 40.2 or 40.3, respectively. A holding-down clip 42, which is attached to caliper 32, for example, by means of a screw 44, is provided for this purpose. A rotational axis of the brake disk 30 is designated as “D”.

The holding-down springs 40.1, 40.2 and 40.3 exhibit passage openings 46.1 to 46.6, which have a longitudinal design. They each extend transversely to the rotational axis D. Projections 16.3 to 16.8, which are formed on the lining carriers 10.3 and 10.4 or the pressure plate 38, extend through the above-named passage openings.

As can be gathered from FIG. 3, the projection 16.3 protrudes downwards, i.e. facing the brake disk, beyond the passage opening 46.1 in the direction of the rotational axis D in FIG. 3. The projection 16.4 projects, facing away from the brake disk, beyond the passage opening 46.2. The projection 16.5 is twisted vis-à-vis the orientation of the passage opening 46.3, which is why it projects beyond the passage opening 46.3, both facing the brake disk and facing away from the brake disk. Due to its dimensions, the projection 16.6 projects beyond the passage opening 46.4, both facing the brake disk and facing away from the brake disk.

Even though FIG. 3 does not show the specific details, it is also provided that the projections 16.7 and 16.8 project beyond the passage openings 56.5 or 46.6 in the direction of the rotational axis D. In this context, reference is being made to the embodiment based on FIG. 4.

It is explicitly emphasized that the manner in which the projections 16.3 to 16.8 project beyond the respective passage openings 46.1 to 46.6 is depicted in FIGS. 3 and 4 only by way of example. They need not be all different. It is possible, instead, that they all have the same design or a different design by groups.

FIG. 5 again shows schematically different implementations of the invention. For example, a projection 50 is formed on a lining carrier 48, with said projection 50 having a width B1 only in a subarea, with said width B1 being greater than a width B3 of a passage opening 52 of a holding-down spring 54, while it has a width B2 corresponding to a width B3 in a different subarea. The situation with the pressure plate 56 shown in FIG. 5 is different. Its projection 58 has an approximately consistently greater width than a passage opening 60 of a holding-down spring 62. But the projection 58 can also be designed just like projection 50.

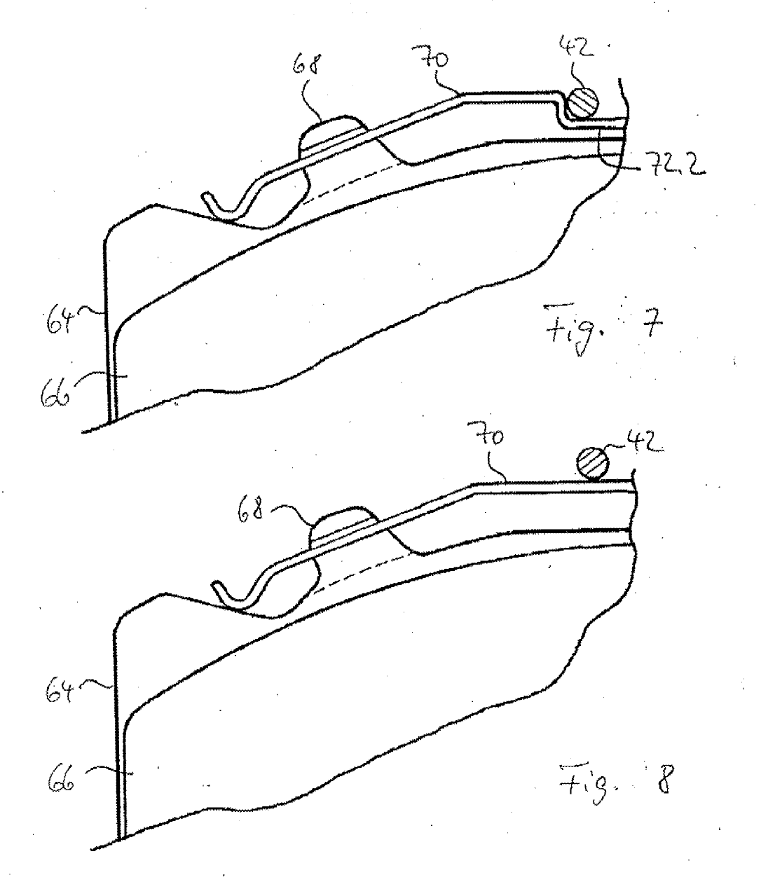

FIGS. 6 to 8 each show a lining carrier 64 with a friction lining 66 and a holding-down spring 70, which a projection 68 engages behind. In FIGS. 6 and 7, a radial projection 72.1, respectively 72.2 is provided, serving to hold the holding-down spring 70 stationary in the circumferential direction of the brake disk 30 (FIG. 30) by means of the holding-down clip 42. Depending on the installation position relative to the rotational axis, a radial and/or tangential direction of the preloading can be preset. Such a radial projection is not provided in the embodiment according to FIG. 8. Accordingly, only preloadings in the radial direction are generated in this case.

FIGS. 9a) and b) show schematic sectional views through the lining carrier 10.3 with the associated holding-down spring 40.1. As can be gathered especially from FIG. 9b), there is the possibility of a relative movement of the lining carrier 10.3 relative to the holding-down spring 40.1.

But this relative movement is limited in that the projection 16.3 projects beyond the passage opening 46.1 in the axial direction of the brake disk 30 (FIG. 3). A maximum deflection is shown in FIG. 9b) on the right side.

As can be gathered especially from FIG. 9a), a stop surface 74 on the projection 16.3 and a stop surface 76 on the holding-down spring 40.1 have a consistent planar design, making it possible for a relative movement of the holding-down spring 40.1 with respect to the lining carrier 10.3 to occur in the circumferential direction of the brake disk 30 without tilting or jamming, even in the operating state shown in FIG. 9b) on the right side. Such a relative movement is possible because the passage opening 46.1 is longer than the projection 16.3.

FIG. 9c) shows the lining carrier 10.4 with the projection 16.6.

FIG. 9d) shows a lining carrier 78 with a projection 80. The free end 80.1 of the projection 80 is set at an angle with respect to the section 80.2 extending through a passage opening 82 of the holding-down spring 84. In the embodiment shown, the setting angle α is approximately 29°. However, a setting angle of 10° has been proven to be of value, which is why this value is preferred. The pitching has the effect that the projection 80 projects beyond the holding-down spring 84.

The fact that a projection on a lining carrier or a pressure plate virtually engages behind the holding-down spring prevents excessive lifting of the holding-down spring. This effect is present from the beginning of the coupling and effectively prevents, especially in the installed state, a “rebounding” of a spring leg of the holding-down spring and a detachment from the contact surface under extreme conditions. The protruding contact surface offers the additional advantage that a joint axial movement (holding-down spring with lining carrier/pressure plate) can be executed, while relative movements are possible in the circumferential direction (tangential direction) of the brake disk. In other words, the lining carrier and/or the pressure plate do not establish a positive locking or positive connection with the spring leg in this direction. That is to say, the length of the passage opening in the spring legs is greater than the respective extension of the associated projection on the lining carrier/the pressure plate. In addition, the protruding contact surface constitutes a “sliding zone” with its side facing the associated spring leg.

The protruding area of the projection results in another functional advantage in the form of a protection against tilting for the holding-down spring with respect to the lining carrier. This is relevant especially in the event that heavy soiling interferes with a joint axial shift relative to the holding-down clip. In this case, the spring leg can rest on the contact surface.

In general, it does not matter and it is irrelevant to the function of the contact surface whether the holding-down spring exhibits the above-mentioned radial projections at the center for stationary lateral retention by means of the holding-down clip and whether the holding-down clip is arranged with or without offset vis-à-vis the brake axis on the brake caliper for the presetting of a direction of a spring preloading. It is similarly irrelevant whether and, if so, where the ends of the spring legs butt or rest against the lining carrier/the pressure plate. Furthermore it is irrelevant whether the holding-down spring exhibits symmetrical or unsymmetrical spring legs in relation to the leg extension.

The effect of the protruding projection is present in all implementations of the center area of the holding-down spring between the two lateral spring legs and the extensions of the spring legs. In other words, the protruding area of the projection effectively prevents detachment, skipping or tilting with subsequent loss of lining carrier or the pressure plate in the event that one or both spring legs rebound to an extreme extent.

The function in accordance with the invention in the installed state is already revealed by the above explanations. The touchdown of the holding-down spring on the lining carrier or pressure plate equipped with the projections according to the invention proceeds in a simple manner in that the spring is pushed into the inclined/tilted position, depending on the implementation of the projection. The spring assumes its final position when it is pushed by means of the holding-down clip. This also determines the size as well as the direction of a potential preload force. In this process, the brake pad with the lining carrier is then positioned in the guides/supports of the brake caliper and/or the brake carrier.

The features of the invention disclosed in the above description, the claims as well as the drawing can be essential both individually and in any combination for the implementation of the invention in its various embodiments.

1. Disk brake, in particular for utility vehicles, having
a brake disk with a rotational axis,
a pressure device which, for braking, is pressed in the direction of the rotational axis against the brake disk, and
a holding-down device in the form of a leaf spring, wherein
the pressing device exhibits a projection which, in the installed state, extends through a passage opening in the holding-down device,
the projection, in the installed state, projects beyond a delimitation of the passage opening in the axial direction of the brake disk and
a rebound delimitation for one or both spring legs of the leaf spring is formed by the protrusion of the projection.

2. Disk brake in accordance with claim 1, characterized in that the holding-down device is kept stationary in the circumferential direction of the brake disk.

3. Disk brake in accordance with claim 1, characterized in that the holding-down device exhibits a radial projection by which it is kept stationary in the circumferential direction of the brake disk by means of a holding-down clip.

4. Disk brake in accordance with claim 1, characterized in that the projection, in the installed state, projects beyond a delimitation of the passage opening in the axial direction of the brake disk both facing the brake disk and facing away from the brake disk.

5. Disk brake in accordance with claim 1, characterized in that the projection is twisted, in the top view of its free end, with respect to the passage opening.

6. Disk brake in accordance with claim 1, characterized in that the free end of the projection is set at an angle with respect to the section of the projection which, in the installed state, extends through the passage opening.

7. Disk brake in accordance with claim 6, characterized in that the setting angle is 5° to 40°, preferably 5° to 20°.

8. Disk brake in accordance with claim 1, characterized in that the projection is compressed, flanged, bent and/or twisted, at least in sections, in order to form the projecting end.

9. Disk brake in accordance with claim 1, characterized in that the projecting end is cast on.

10. Disk brake in accordance with any claim 1, characterized in that a surface of the projection facing the holding-down device in the installed state corresponds to the respective surface of the holding-down device.

11. Disk brake in accordance with claim 1, characterized in that, given two projections one projection projects beyond a delimitation of a passage opening on the one side in the axial direction of the brake disk and the other projection respectively projects on the other side.

12. Disk brake in accordance with claim 1, characterized in that the pressing device and the holding-down device are movable with respect to each other, in the installed state, in the tangential direction of the brake disk.

13. Disk brake in accordance with claim 1, characterized in that the pressing device is a lining carrier.

14. Disk brake in accordance with claim 1, characterized in that the pressing device is a pressure plate.

15. Lining carrier for a disk brake in accordance with claim 13.

16. Pressure plate for a disk brake in accordance with claim 14.
